(19) United States
(12) Patent Application Publication
(10) Pub. No.: US 2020/0193313 A1
(43) Pub. Date: Jun. 18, 2020

(54) INTERPRETABILITY-BASED MACHINE LEARNING ADJUSTMENT DURING PRODUCTION

(71) Applicant: Parallel Machines, Inc., Sunnyvale, CA (US)

(72) Inventors: SINDHU GHANTA, San Mateo, CA (US); DREW ROSELLI, Woodinville, WA (US); NISHA TALAGALA, Saratoga, CA (US); VINAY SRIDHAR, San Jose, CA (US); SWAMINATHAN SUNDARARAMAN, San Jose, CA (US); LIOR AMAR, Sunnyvale, CA (US); LIOR KHERMOSH, Palo Alto, CA (US); BHARATH RAMSUNDAR, Fremont, CA (US); SRIRAM SUBRAMANIAN, Dallas, TX (US)

(73) Assignee: Parallel Machines, Inc., Sunnyvale, CA (US)

(21) Appl. No.: 16/221,039

(22) Filed: Dec. 14, 2018

(51) Int. Cl. G06N 5/04; G06N 20/00; G06F 16/9038; G06K 9/62

(52) U.S. Cl. CPC G06N 5/046; G06K 9/6256; G06F 16/9038; G06N 20/00

(57) ABSTRACT

Apparatuses, systems, program products, and methods are disclosed for interpretability-based machine learning adjustment during production. An apparatus includes a first results module that is configured to receive a first set of inference results of a first machine learning algorithm during inference of a production data set. An apparatus includes a second results module that is configured to receive a second set of inference results of a second machine learning algorithm during inference of a production data set. An apparatus includes an action module that is configured to trigger one or more actions that are related to a first machine learning algorithm in response to a comparison of first and second sets of inference results not satisfying explainability criteria.

### FIELD

This invention relates to machine learning and more particularly relates to adjusting machine learning algorithms/models during production based on explainability criteria.

### BACKGROUND

Machine learning is being integrated into a wide range of use cases and industries. Unlike other types of applications, machine learning (including deep learning and advanced analytics) has multiple independent running components that must operate cohesively to deliver accurate and relevant results. Furthermore, slight changes to input data can cause non-linear changes in the results. This inherent complexity makes it difficult to manage or monitor all the interdependent aspects of a machine learning system.

### SUMMARY

Apparatuses, systems, program products, and method are disclosed for interpretability-based machine learning adjustment during production. An apparatus, in one embodiment, includes a first results module that is configured to receive a first set of inference results of a first machine learning algorithm during inference of a production data set. In further embodiments, an apparatus includes a second results module that is configured to receive a second set of inference results of a second machine learning algorithm during inference of a production data set. An apparatus, in some embodiments, includes an action module that is configured to trigger one or more actions that are related to a first machine learning algorithm in response to a comparison of first and second sets of inference results not satisfying explainability criteria.

A method for interpretability-based machine learning adjustment during production, in one embodiment, includes receiving a first set of inference results of a first machine learning algorithm during inference of a production data set. In further embodiments, a method includes receiving a second set of inference results of a second machine learning algorithm during inference of a production data set. A method, in some embodiments, includes triggering one or more actions that are related to a first machine learning algorithm in response to a comparison of first and second sets of inference results not satisfying explainability criteria.

In one embodiment, an apparatus for interpretability-based machine learning adjustment during production includes means for receiving a first set of inference results of a first machine learning algorithm during inference of a production data set. In further embodiments, an apparatus includes means for receiving a second set of inference results of a second machine learning algorithm during inference of a production data set. An apparatus, in some embodiments, includes means for triggering one or more actions that are related to a first machine learning algorithm in response to a comparison of first and second sets of inference results not satisfying explainability criteria.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for interpretability-based machine learning adjustment during production;

FIG. 2A is a schematic block diagram illustrating one embodiment of a logical machine learning layer for interpretability-based machine learning adjustment during production;

FIG. 2B is a schematic block diagram illustrating another embodiment of a logical machine learning layer for interpretability-based machine learning adjustment during production;

FIG. 2C is a schematic block diagram illustrating a certain embodiment of a logical machine learning layer for interpretability-based machine learning adjustment during production;

FIG. 3 is a schematic block diagram illustrating one embodiment of an apparatus for interpretability-based machine learning adjustment during production;

FIG. 4 is a schematic flow chart diagram illustrating one embodiment of a method for interpretability-based machine learning adjustment during production; and

FIG. 5 is a schematic flow chart diagram illustrating another embodiment of a method for interpretability-based machine learning adjustment during production.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

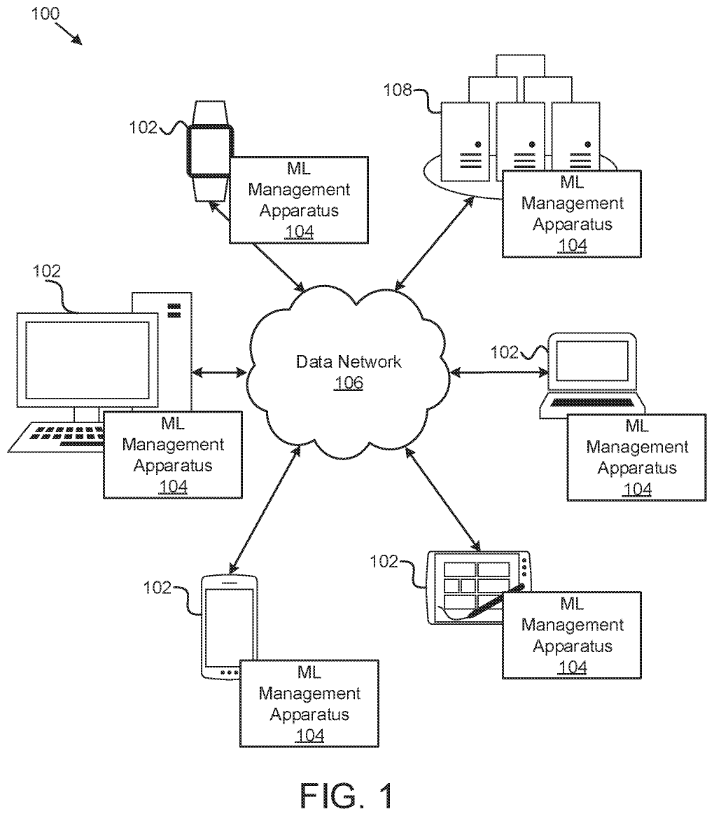

FIG. 1 is a schematic block diagram illustrating one embodiment of a system 100 for interpretability-based machine learning adjustment during production. In one embodiment, the system 100 includes one or more information handling devices 102, one or more ML management apparatuses 104, one or more data networks 106, and one or more servers 108. In certain embodiments, even though a specific number of information handling devices 102, ML management apparatuses 104, data networks 106, and servers 108 are depicted in FIG. 1, one of skill in the art will recognize, in light of this disclosure, that any number of information handling devices 102, ML management apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include executable code, functions, instructions, operating systems, and/or the like for performing various machine learning operations, as described in more detail below.

In one embodiment, the ML management apparatus 104 is configured to determine whether an interpretability or explainability algorithm and/or model is accurately interpreting or explaining a machine learning algorithm or model that is in production. Machine learning models may be used to generate predictions or forecasts for making critical decisions such as the likelihood that a person will commit a future crime, trustworthiness for a loan approval, a medical diagnosis, and/or the like. Machine learning models, and the generated results, may include various biases based on gender, geographic location, race, or the like, which may have a negative impact on persons who are directly affected by decisions that are made based on the results. Thus, industries and governments may enact regulations that require that the machine learning results that are used to make decisions be interpretable or explainable.

Accordingly, as used herein, interpretability or explainability refers to the degree in which an observer may understand the cause of decision. In a machine learning sense, therefore, interpretability or explainability refers to the ability to interpret or explain how a machine learning model generated results, why the machine learning model generated the results, and/or the like. As machine learning models become more and more complex, however, it may be difficult to directly interpret or explain the machine learning results, especially if these models are already in deployment. A second machine learning algorithm or model may be used to approximate the complex machine learning algorithms or models that are already in deployment, either globally or in parts. The second machine learning algorithm or model may be an algorithm/model that is known to be interpretable/explainable and is used to provide human understandable explanations of the machine learning results that the more complex machine learning algorithm/model generates. The interpretable machine learning algorithm/model may be known as a canary model.

Oftentimes in production, however, data seen during inference may diverge from the kind of data seen during training in unpredictable ways, which may cause predictions of the complex/primary model and the canary model to diverge. In such an embodiment, the canary model may no longer be a good approximation of the complex/primary model. This may render the complex/primary model under deployment and in production uninterpretable/unexplainable, which may violate the intended interpretability/explainability requirements.

The ML management apparatus 104, in one embodiment, is configured to continuously monitor both the complex/primary machine learning algorithm/model and the canary/secondary machine learning algorithm/model during inference (e.g., while deployed and/or in live production) and generate alerts or take actions related to the complex/primary machine learning algorithm/model whenever explainability criteria is violated. The violation of explainability criteria, described in more detail below, may indicate that the canary/secondary machine learning algorithm/model is no longer an accurate representation, approximation, estimation, or the like of the complex/primary machine learning algorithm/model.

As explained in more detail below, a machine learning system may involve various components, pipelines, data sets, and/or the like—such as training pipelines, orchestration/management pipelines, inference pipelines, and/or the like. Furthermore, components may be specially designed or configured to handle specific objectives, problems, and/or the like. In some machine learning systems, a user may be required to determine which machine learning components are necessary to analyze a particular problem/objective, and then manually determine the inputs/outputs for each of the components, the limitations of each component, events generated by each component, and/or the like. Furthermore, with some machine learning systems, it may be difficult to track down where an error occurred, what caused an error, why the predicted results weren't as accurate as they should be, whether the machine learning model is suitable for a particular inference data set, and/or the like, due to the numerous components and interactions within the system.

In one embodiment, the ML management apparatus 104 provides an improvement for machine learning systems by receiving a set of inference results that the primary machine learning algorithm/model generates on a production data set, receiving a set of inference results that a secondary or canary machine learning algorithm/model generates on the production data set, and comparing the different sets of results to determine whether explainability criteria has been violated, and if so, triggering an action related to the primary machine learning algorithm/model.

During training, in certain embodiments, the ML management apparatus 104 can determine whether a selected canary machine learning algorithm/model is a good approximation of the behavior of the complex/primary machine learning algorithm/model by comparing the results, predictions, or the like of the two algorithms/models, e.g., using a root-mean-square error (“RMSE”) or other statistical or comparison method. A low error/high similarity between the two sets of predictive results may indicate that the canary algorithm/model is a good approximation of the complex/primary algorithm/model. However, during deployment in a production setting, the assumption that the canary algorithm/model is still a good approximation of the complex/primary algorithm/model may be violated.

For example, if the differences between the first and second sets of inference results indicate that the secondary/canary machine learning algorithm/model is no longer an accurate approximation of the more complex/primary machine learning algorithm/model, then actions may be taken to investigate why the inference results between the two algorithms/models no longer satisfy the explainability criteria and actions may further be taken to correct the determined issues. In this manner, the complex/primary machine learning algorithm/model, which is in live production, can be continuously monitored and corrected, if necessary, dynamically in real-time, e.g., during production.

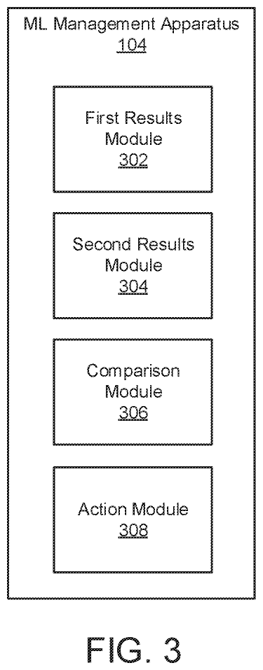

The ML management apparatus 104, including its various sub-modules, may be located on one or more information handling devices 102 in the system 100, one or more servers 108, one or more network devices, and/or the like. The ML management apparatus 104 is described in more detail below with reference to FIG. 3.

In various embodiments, the ML management apparatus 104 may be embodied as a hardware appliance that can be installed or deployed on an information handling device 102, on a server 108, or elsewhere on the data network 106. In certain embodiments, the ML management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the ML management apparatus 104 may include a power interface, a wired and/or wireless network interface, a graphical interface that attaches to a display, and/or a semiconductor integrated circuit device as described below, configured to perform the functions described herein with regard to the ML management apparatus 104.

The ML management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the ML management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the ML management apparatus 104.

The semiconductor integrated circuit device or other hardware appliance of the ML management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the ML management apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The one or more servers 108 may store data associated with an information handling device 102, such as machine learning data, algorithms, training models, and/or the like.

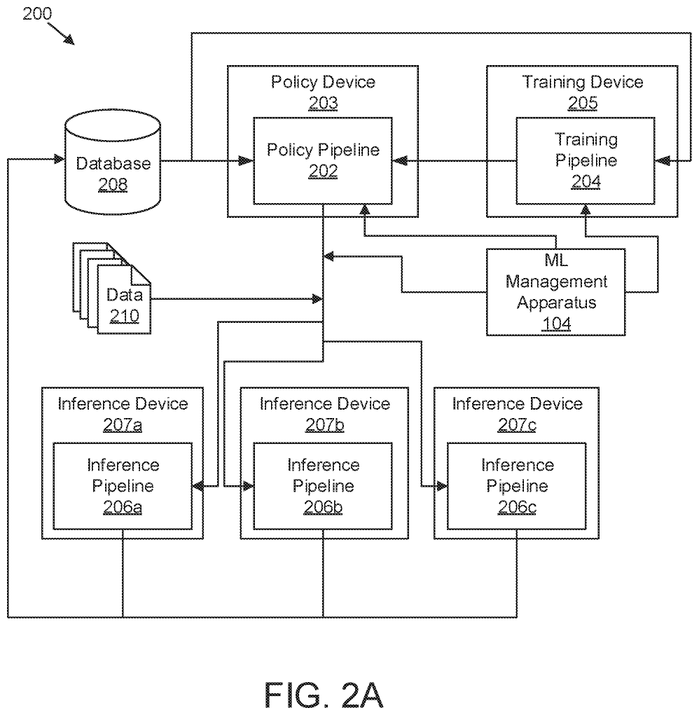

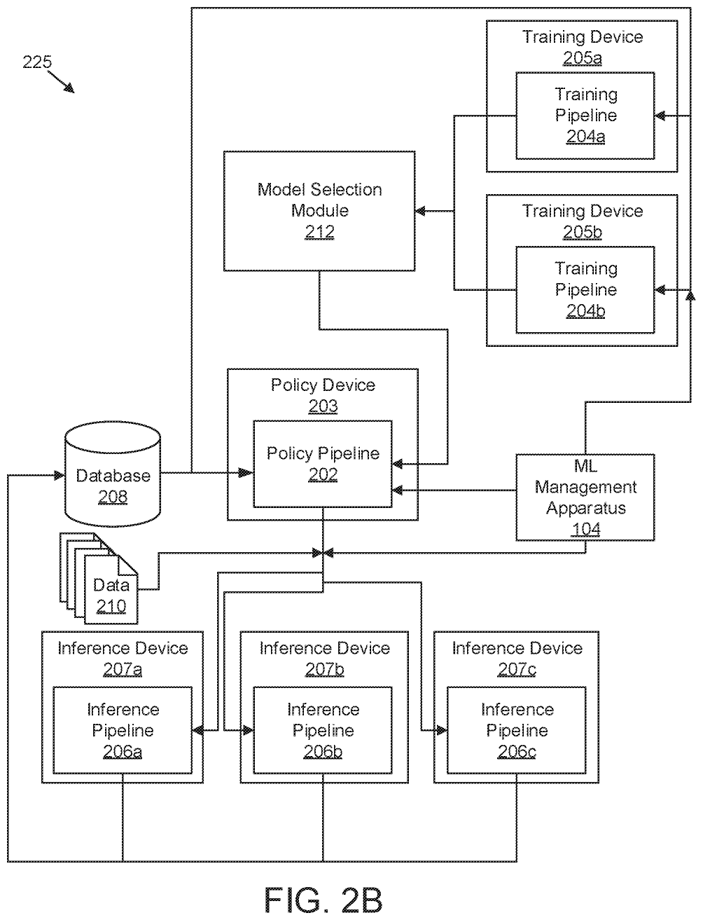

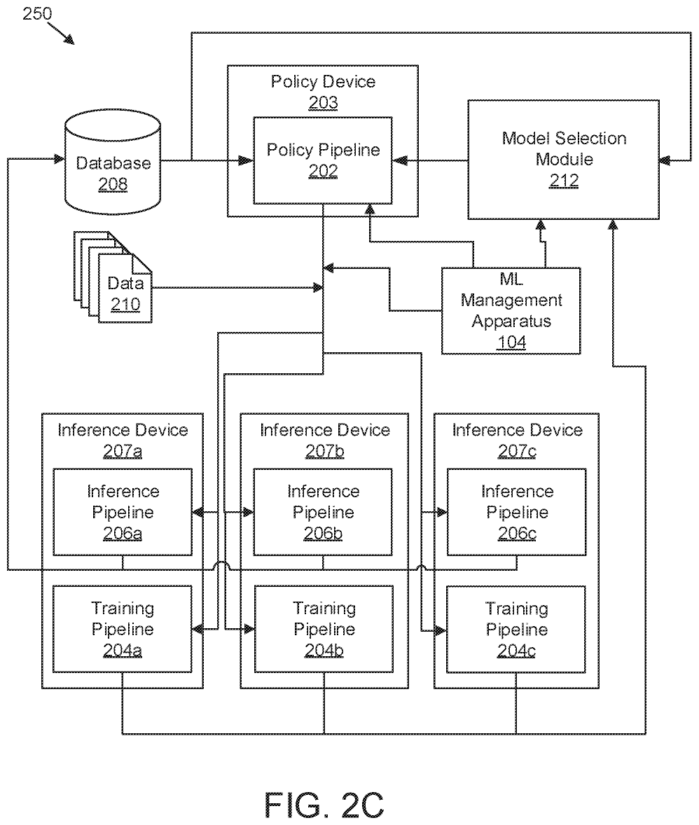

FIG. 2A is a schematic block diagram illustrating one embodiment of a machine learning system 200 for interpretability-based machine learning adjustment during production. In one embodiment, the machine learning system 200, which may be a logical machine learning layer, includes one or more policy/control pipelines 202, one or more training pipelines 204, one or more inference pipelines 206a-c, one or more databases 208 (which may be optional), input data 210, and an ML management apparatus 104. Even though a specific number of machine learning pipelines 202, 204, 206a-c are depicted in FIG. 2A, one of skill in the art, in light of this disclosure, will recognize that any number of machine learning pipelines 202, 204, 206a-c may be present in the logical machine learning layer 200. Furthermore, as depicted in FIG. 2A, the various pipelines 202, 204, 206a-c may be located on different nodes embodied as devices 203, 205, 207a-c such as information handling devices 102 described above, virtual machines, cloud or other remote devices, and/or the like. In some embodiments, the machine learning system 200 includes an embodiment of a logical machine learning layer, also known as an intelligence overlay network (“ION”).

As used herein, machine learning pipelines 202, 204, 206a-c comprise various machine learning features, engines, models, components, objects, modules, and/or the like to perform various machine learning operations such as algorithm training/inference, feature engineering, validations, scoring, and/or the like. Pipelines 202, 204, 206a-c may analyze or process data 210 in batch, e.g., process all the data at once from a static source, streaming, e.g., operate incrementally on live data, or a combination of the foregoing, e.g., a micro-batch.

In certain embodiments, each pipeline 202, 204, 206a-c executes on a device 203, 205, 207a-c, e.g., an information handling device 102, a virtual machine, and/or the like. In some embodiments, multiple different pipelines 202, 204, 206a-c execute on the same device. In various embodiments, each pipeline 202, 204, 206a-c executes on a distinct or separate device. The devices 203, 205, 207a-c may all be located at a single location, may be connected to the same network, may be located in the cloud or another remote location, and/or some combination of the foregoing.

In one embodiment, each pipeline 202, 204, 206a-c is associated with an analytic engine and executes on a specific analytic engine type for which the pipeline is 202, 204, 206a-c configured. As used herein, an analytic engine comprises the instructions, code, functions, libraries, and/or the like for performing machine learning numeric computation and analysis. Examples of analytic engines may include Spark, Flink, TensorFlow, Caffe, Theano, and PyTorch. Pipelines 202, 204, 206a-c developed for these engines may contain components provided in modules/libraries for the particular analytic engine (e.g., Spark-ML/MLlib for Spark, Flink-ML for Flink, and/or the like). Custom programs may also be included that are developed for each analytic engine using the application programming interface for the analytic engine (e.g., DataSet/DataStream for Flink). Furthermore, each pipeline may be implemented using various different platforms, libraries, programming languages, and/or the like. For instance, an inference pipeline 206a may be implemented using Python, while a different inference pipeline 206b is implemented using Java.

In one embodiment, the machine learning system 200 includes physical and/or logical groupings of the machine learning pipelines 202, 204, 206a-c based on a desired objective, result, problem, and/or the like. For instance, the ML management apparatus 104 may select a training pipeline 204 for generating a machine learning model configured for the desired objective and one or more inference pipelines 206a-c that are configured to analyze the desired objective by processing input data 210 associated with the desired objective using the analytic engines for which the selected inference pipelines 206a-c are configured for and the machine learning model. Thus, groups may comprise multiple analytic engines, and analytic engines may be part of multiple groups. Groups can be defined to perform different tasks such as analyzing data for an objective, managing the operation of other groups, monitoring the results/performance of other groups, experimenting with different machine learning algorithms/models in a controlled environment, e.g., sandboxing, and/or the like.

For example, a logical grouping of machine learning pipelines 202, 204, 206a-c may be constructed to analyze the results, performance, operation, health, and/or the like of a different logical grouping of machine learning pipelines 202, 204, 206a-c by processing feedback, results, messages, and/or the like from the monitored logical grouping of machine learning pipelines 202, 204, 206a-c and/or by providing inputs into the monitored logical grouping of machine learning pipelines 202, 204, 206a-c to detect anomalies, errors, and/or the like.

Because the machine learning pipelines 202, 204, 206a-c may be located on different devices 203, 205, 207a-c, the same devices 203, 205, 207a-c, and/or the like, the ML management apparatus 104 logically groups machine learning pipelines 202, 204, 206a-c that are best configured for analyzing the objective. As described in more detail below, the logical grouping may be predefined such that a logical group of machine learning pipelines 202, 204, 206a-c may be particularly configured for a specific objective.

In certain embodiments, the ML management apparatus 104 dynamically selects machine learning pipelines 202, 204, 206a-c for an objective when the objective is determined, received, and/or the like based on the characteristics, settings, and/or the like of the machine learning pipelines 202, 204, 206a-c. In certain embodiments, the multiple different logical groupings of pipelines 202, 204, 206a-c may share the same physical infrastructure, platforms, devices, virtual machines, and/or the like. Furthermore, the different logical groupings of pipelines 202, 204, 206a-c may be merged, combined, and/or the like based on the objective being analyzed.

In one embodiment, the policy pipeline 202 is configured to maintain/manage the operations within the logical machine learning layer 200. In certain embodiments, for instance, the policy pipeline 202 receives machine learning models from the training pipeline 204 and pushes the machine learning models to the inference pipelines 206a-c for use in analyzing the input data 210 for the objective. In various embodiments, the policy pipeline 202 receives user input associated with the logical machine learning layer 200, receives event and/or feedback information from the other pipelines 204, 206a-c, validates machine learning models, facilitates data transmissions between the pipelines 202, 204, 206a-c, and/or the like.

In one embodiment, the policy pipeline 202 comprises one or more policies that define how pipelines 204, 206a-c interact with one another. For example, the training pipeline 204 may output a machine learning model after a training cycle has completed. Several possible policies may define how the machine learning model is handled. For example, a policy may specify that the machine learning model can be automatically pushed to inference pipelines 206a-c while another policy may specify that user input is required to approve a machine learning model prior to the policy pipeline 202 pushing the machine learning model to the inference pipelines 206a-c. Policies may further define how machine learning models are updated.

For instance, a policy may specify that a machine learning model be updated automatically based on feedback; e.g.; based machine learning results received from an inference pipeline 206a-c; a policy may specify whether a user is required to review, verify, and/or validate a machine learning model before it is propagated to inference pipelines 206a-c; a policy may specify scheduling information within the logical machine learning layer 200 such as how often a machine learning model is update (e.g., once a day, once an hour, continuously, and/or the like); and/or the like.

Policies may define how different logical groups of pipelines 202, 204, 206a-c interact or cooperate to for a cohesive data intelligence workflow. For instance, a policy may specify that the results generated by one logical machine learning layer 200 be used as input into a different logical machine learning layer 200, e.g., as training data for a machine learning model, as input data 210 to an inference pipeline 206a-c, and/or the like. Policies may define how and when machine learning models are updated, how individual pipelines 202, 204, 206a-c communicate and interact, and/or the like.

In one embodiment, the policy pipeline 202 maintains a mapping of the pipelines 204, 206a-c that comprise the logical grouping of pipelines 204, 206a-c. The policy pipeline may further adjust various settings or features of the pipelines 204, 206a-c in response to user input, feedback or events generated by the pipelines 204, 206a-c, and/or the like. For example, if an inference pipeline 206a generates machine learning results that are inaccurate, the policy pipeline 202 may receive a message from the inference pipeline 202 that indicates the results are inaccurate, and may direct the training pipeline 204 to generate a new machine learning model for the inference pipeline 206a.

The training pipeline 204, in one embodiment, is configured to generate a machine learning model for the objective that is being analyzed based on historical or training data that is associated with the objective. As used herein, a machine learning model is generated by executing a training or learning algorithm on historical or training data associated with a particular objective. The machine learning model is the artifact that is generated by the training process, which captures patterns within the training data that map the input data to the target, e.g., the desired result/prediction. In one embodiment, the training data may be a static data set, data accessible from an online source, a streaming data set, and/or the like.

The inference pipelines 206a-c, in one embodiment, use the generated machine learning model and the corresponding analytics engine to generate machine learning results/predictions on input/inference/production data 210 that is associated with the objective. The input data may comprise data associated with the objective that is being analyzed, but was not part of the training data, e.g., the patterns/outcomes of the input data are not known. For example, if a user wants to know whether an email is spam, the training pipeline 204 may generate a machine learning model using a training data set that includes emails that are known to be both spam and not spam. After the machine learning model is generated, the policy pipeline 202 pushes the machine learning model to the inference pipelines 206a-c, where it is used to predict whether one or more emails, e.g., provided as input/inference/production data 210, are spam.

Thus, as depicted in FIG. 2A, a policy pipeline 202, a training pipeline 204 and inference pipelines 206a-c are depicted in an edge/center graph. In the depicted embodiment, new machine learning models are periodically trained in a batch training pipeline 204, which may execute on a large clustered analytic engine in a data center. As the training pipeline 204 generates new machine learning models, an administrator may be notified. The administrator may review the generated machine learning models, and if the administrator approves, the machine learning models are pushed to the inference pipelines 206a-c that comprise the logical pipeline grouping for the objective, each of which is executing on live data coming from an edge device, e.g., input/inference/production data 210.

FIG. 2B is a schematic block diagram illustrating another embodiment of a logical machine learning layer 225 for interpretability-based machine learning adjustment during production. In one embodiment, the logical machine learning layer 225 of FIG. 2B is substantially similar to the logical machine learning layer 200 depicted in FIG. 2A. In addition to the elements of the logical machine learning layer 200 depicted in FIG. 2A, the logical machine learning layer 225 of FIG. 2B includes a plurality of training pipelines 204a-b, executing on training devices 205a-b.

In the depicted embodiment, the training pipelines 204a-b generate machine learning models for an objective, based on training data for the objective. The training data may be different for each of the training pipelines 204a-b. For instance, the training data for a first training pipeline 204a may include historical data for a predefined time period while the training data for a second training pipeline 204b may include historical data for a different predefined time period. Variations in training data may include different types of data, data collected at different time periods, different amounts of data, and/or the like.

In other embodiments, the training pipelines 204a-b may execute different training or learning algorithms on different or the same sets of training data. For instance, the first training pipeline 204a may implement a training algorithm TensorFlow using Python, while the second training pipeline 204b implements a different training algorithm in Spark using Java, and/or the like.

In one embodiment, the logical machine learning layer 225 includes a model selection module 212 that is configured to receive the machine learning models that the training pipelines 204a-b generate and determine which of the machine learning models is the best fit for the objective that is being analyzed. The best-fitting machine learning model may be the machine learning model that produced results most similar to the actual results for the training data (e.g., the most accurate machine learning model), the machine learning model that executes the fastest, the machine learning model that requires the least amount of configuration, and/or the like.

In one embodiment, the model selection module 212 performs a hyper-parameter search to determine which of the generated machine learning models is the best fit for the given objective. As used herein, a hyper-parameter search, optimization, or tuning is the problem of choosing a set of optimal hyper-parameters for a learning algorithm. In certain embodiments, the same kind of machine learning model can require different constraints, weights, or learning rates to generalize different data patterns. These measures may be called hyper-parameters, and may be tuned so that the model can optimally solve the machine learning problem. Hyper-parameter optimization finds a set of hyper-parameters that yields an optimal machine learning model that minimizes a predefined loss function on given independent data. In certain embodiments, the model selection module 212 combines different features of the different machine learning models to generate a single combined model. In one embodiment, the model selection module 212 pushes the selected machine learning model to the policy pipeline 202 for propagation to the inference pipelines 206a-c. In various embodiments, the model selection module 212 is part of, communicatively coupled to, operatively coupled to, and/or the like the ML management apparatus 104.

FIG. 2C is a schematic block diagram illustrating a certain embodiment of a logical machine learning layer 250 for interpretability-based machine learning adjustment during production. In one embodiment, the logical machine learning layer 250 of FIG. 2C is substantially similar to the logical machine learning layers 200, 225 depicted in FIGS. 2A and 2B, respectively. In further embodiments, FIG. 2C illustrates a federated learning embodiment of the logical machine learning layer 250.

In a federated machine learning system, in one embodiment, the training pipelines 204a-c are located on the same physical or virtual devices as the corresponding inference pipelines 206a-c. In such an embodiment, the training pipelines 204a-c generate different machine learning models and send the machine learning models to the model selection module 212, which determines which machine learning model is the best fit for the logical machine learning layer 250, as described above, or combines/merges the different machine learning models, and/or the like. The selected machine learning model is pushed to the policy pipeline 202, for validation, verification, or the like, which then pushes it back to the inference pipelines 206a-c.

FIG. 3 is a schematic block diagram illustrating one embodiment of an apparatus 300 for interpretability-based machine learning adjustment during production. In one embodiment, the apparatus 300 includes an embodiment of an ML management apparatus 104. The ML management apparatus 104, in one embodiment, includes one or more of a first results module 302, a second results module 304, a comparison module 306, and an action module 308, which are described in more detail below.

In one embodiment, the first results module 302 is configured to receive a first set of inference results of a first machine learning algorithm/model during inference of a production data set. The first set of inference results may include predictions, estimates, forecasts, and/or other predictive results that the first machine learning algorithm/model generates based on the production data set. The production data set may be a live data set, e.g., real-world data that is generated and analyzed in real-time using the first machine learning algorithm/model. The machine learning model for the first machine learning algorithm may be trained using a training data set that is similar to, emulates, or the like the production data set.

The first machine learning algorithm may be a complex or primary machine learning algorithm/model that is a live production machine learning algorithm/model for analyzing production data, in real-time, to generate a set of inference results. The first machine algorithm/model, for example, may comprise an artificial neural network such as a multilayer perceptron (“MLP”) that includes multiple different layers of nodes or pipelines. Other complex machine learning algorithms/models may include deep learning algorithms/models, ensemble algorithms/models (e.g., an algorithm that includes a combination of multiple different machine learning algorithms/models), boosting algorithms/models, bagging algorithms/models, support vector machines, and/or the like. For example, the first machine learning algorithm/model may be an MLP algorithm/model that is deployed in production for analyzing email messages in real-time, e.g., as they are received, to flag or otherwise indicate email messages that are spam or junk mail.

The inference results may include a list, a table, a database, and/or other data structure that stores the inference results—machine learning predictions, forecasts, estimations, or the like that the first machine learning algorithm/model generates. The first results module 302 may store the inference results locally or on a remote device, e.g., a cloud device for future reference, processing, and analysis. The first results module 302 may query, reference, check, or the like a data structure for the results, may poll for the results, may receive results that are pushed to it, and/or the like. The first results module 302 may receive the results as the results are generated (e.g., after each result is generated), in a batch or set of results (e.g., every 100 results), after an interval of time (e.g., every thirty seconds, every minute, or the like), and/or the like.

In one embodiment, the second results module 304 is configured to receive a second set of inference results of a second machine learning algorithm/model during inference of the production data set. As explained above, the second machine learning algorithm/model may be different than the first machine learning algorithm/model and may be configured to mimic a behavior of the first machine learning algorithm/model. In certain embodiments, the second machine learning algorithm/model is an explainable or interpretable machine learning algorithm/model, e.g., a simpler algorithm/model, that expresses similar characteristics, behaviors, outputs, results, or the like of the first machine learning algorithm/model. In other words, the second machine learning algorithm/model may be a canary machine learning algorithm/model, which, as used herein, may be a simpler machine learning algorithm/model that mimics the behavior of a more complex machine learning algorithm/model (e.g., the first machine learning algorithm/model described herein).

Examples of canary machine learning algorithms/models that may be used may include decision tree models, logistic regression models, linear models, RuleFit models, Naïve Bayes models, k-nearest neighbors models, and/or the like. The foregoing list of machine learning algorithms/models are explainable or interpretable, e.g., the models/algorithms may be used to determine how and why the models/algorithms generated the results or predictions that are generated. Furthermore, the canary models/algorithms may mimic or simulate behaviors of more complex machine learning models/algorithms, and therefore may be used as an approximation or estimation of more complex machine learning algorithms/models that may otherwise not be interpretable or explainable.

The second machine learning algorithm/model, in one embodiment, is trained using the same, or substantially similar, training data as the first machine learning algorithm/model. In this manner, variability in the machine learning results between the first and second machine learning algorithms/models may not be attributable to the data set that is used to train the models. Furthermore, because the first and second machine learning algorithms/models are trained using the same training data set, the second machine learning algorithm/model may be used to analyze or process the same live production data as the first machine learning algorithm/model. In this manner, the results that the first and second machine learning algorithms/models can be compared to determine if the data seen in production during inference diverges from the kind of data seen during training.

In certain embodiments, the second results module 304 selects the second machine learning algorithm/model that is used to approximate the first machine learning algorithm/model from a plurality of available or possible machine learning algorithms/models that are explainable or interpretable. The second results module 304, for instance, may train each of the plurality of available machine learning algorithms/models to determine which of the models generates results that are the closest to, or that are within a threshold value of results that the first machine learning algorithm/model generates for the same training data set.

In further embodiments, the second machine learning algorithm/model that is selected to approximate the first machine learning algorithm/model may further be trained on the same data set as the first machine learning algorithm/model, with the modification that the labels in the training data set are replaced by the results or predictions that the first machine learning algorithm/model generates.

In one embodiment, the comparison module 306 is configured to compare the results that the first machine learning algorithm/model and the second machine learning algorithm/model generates to determine a comparison metric that indicates a difference between the results, which may violate the explainability criteria. As used herein, explainability criteria may include an explainability threshold, value, metric, or the like that indicates that the second/canary machine learning algorithm/model is no longer a good approximation of the first/primary machine learning algorithm/model, and therefore may not be able to explain or interpret the first/primary machine learning algorithm/model. Alternatively, violation of the explainability criteria may indicate that an anomaly, or other factor has occurred in the first machine learning algorithm/model, and that a corrective action should be taken.

The comparison module 306, for example, may calculate the difference between the results (assuming the results include numerical values) to determine the amount (e.g., the comparison metric) of the difference. In some embodiments, if the difference between two results is greater than the explainability threshold, then the comparison module 306 may determine that the second machine learning algorithm/model is no longer a good approximation of the first machine learning algorithm/model. For example, if the difference is greater than a predetermined threshold, e.g., 0.5, 1, 5, or the like, then the explainability criteria is violated.

The comparison module 306 may perform various statistical or other comparison methods for comparing the inference results to calculate a comparison metric. For example, the comparison module 306 may calculate a root-mean-square error (“RMSE”), a mean absolute error (“MAE”), and/or other statistical or comparison methods for comparing two or more values. In such an embodiment, the explainability criteria may include a threshold RMSE, a threshold MAE, and/or the like.

In some embodiments, the comparison module 306 compares results between the first inference data set that the first machine learning algorithm/model generates and the second inference data set that the second machine learning algorithm/model generates on a per-result basis, e.g., a result-by-result basis. For example, the comparison module 306 may calculate the difference or RMSE value for each result for the first and second sets of inference data as the results are generated. In such an embodiment, if the difference or RMSE violates the explainability criteria, e.g., exceeds the difference or RMSE threshold, then the second machine learning algorithm/model, e.g., the canary algorithm/model may no longer be an accurate approximation of the first machine learning algorithm/model.

In further embodiments, the comparison module 306 compares sets of results, subsets of results, and/or the like according to a predefined or predetermined number of results. For example, the comparison module 306 may calculate the RMSE for the most recent 100 results for the first and second sets of inference results. If the calculated metric, e.g., the RMSE for the result sets that are compared violates the explainability criteria, e.g., a predefined RMSE threshold, then the second machine learning algorithm/model may no longer be an accurate approximation of the first machine learning algorithm/model.

Furthermore, in certain embodiments, the comparison module 306 determines whether a predefined or predetermined number of result comparisons violate the explainability criteria to conclude that the second machine learning algorithm/model is not an accurate approximation of the first machine learning algorithm/model. For instance, if only one result comparison within a set of 500 result comparisons violates the explainability criteria, this may indicate that the result comparison that violated the explainability criteria is an outlier and is not indicative that the second machine learning algorithm/model is not an accurate approximation of the first machine learning algorithm/model.

On the other hand, if 450 result comparisons within a set of 500 result comparisons violate the explainability criteria, then that may be an indication that the second machine learning algorithm/model is no longer an accurate approximation of the first machine learning algorithm/model. Accordingly, the explainability criteria may further include an occurrence threshold, e.g., a percentage, value, number, or the like that indicates how many result comparisons are needed within a set of a predetermined number, within a predefined time interval (time frame, time period), and/or the like, that violate the explainability threshold to indicate that the second machine learning algorithm/model is not an accurate approximation of the first machine learning algorithm/model.

In certain embodiments, the comparison module 306 further compares the comparison metrics for the first and second inference results that are generated on the production data set to comparison metrics for training results that the first and second machine learning algorithms/models generate based on training data to detect, determine, identify, or the like the presence of data deviation or drift from the training data that was used train the first and second machine learning models. As used herein, data deviation may refer to a point where inference results that a machine learning algorithm/model generates while in production deviates or drifts a threshold amount from training results that the machine learning algorithm/model generates during training. Once the data deviation is identified, various actions, described below, may be taken to correct for the data deviation.

In one embodiment, the action module 308 is configured to trigger one or more actions related to the first machine learning algorithm/model in response to the comparison of the first and second sets of inference results that the first and second machine learning algorithms/models generate not satisfying the explainability criteria. In other words, if the comparison between the first and second inference results do not satisfy the explainability threshold(s), then the second machine learning algorithm/model may not be an accurate representation of the first machine learning algorithm/model.

In such an embodiment, the action module 308 may trigger, cause, enable, signal, perform, or the like an action related to the first machine learning model/algorithm. For instance, the action module 308 may send an alert notification, message, signal, flag, or the like, that indicates that the explainability criteria was not satisfied, or was violated. The alert notification may include one or more recommendations for responding to the explainability criteria violation. The recommendations may include retraining the first machine learning model, swapping or switching the first machine learning model with a different machine learning model, switching production inference to the second/canary machine learning algorithm/model, and/or the like.

In one embodiment, the action module 308 dynamically (e.g., while in production) or automatically changes the current machine learning model that is in production, e.g., the first machine model for the first machine learning algorithm to a different machine learning model that may satisfy the explainability criteria (while maintaining the same second machine learning algorithm/model), that may result in the lowest data-deviation, and/or the like. In one embodiment, the action module 308 automatically switches the machine learning model for the first machine learning algorithm to a different machine learning model. In such an embodiment, the action module 308 may trigger training different machine learning models for different machine learning algorithms, may cause machine learning models to be trained using different training data, or the like until the explainability criteria is satisfied.

In one embodiment, the action module 308 dynamically retrains a machine learning model for the first machine learning algorithm using training data that generates inference results that satisfy the explainability criteria. The action module 308, for example, may select or iterate over different training data sets that can be used to retrain the machine learning model for the first machine learning algorithm until the predictions or results satisfy the explainability criteria. The training data sets may include recent sets of production data, training data that is similar to the production data, and/or the like.

In certain embodiments, the action module 308 prompts a user for confirmation to switch machine learning models, retrain the machine learning model using different training data, and/or the like. The user may provide a simple Yes/No response to indicate whether the automatically switch machine learning models and/or automatically train or retrain the machine learning model. Furthermore, in some embodiments, the user may further select a particular machine learning model to switch to or a training data set to use to train or retrain the machine learning model.

In one embodiment, the action module 308 dynamically and/or automatically switches live production of inference results for the production data set to the second machine learning algorithm/model. For instance, the action module 308 may switch live production of inference results for a production data set to the canary machine learning algorithm/model such that the inference results that the canary machine learning algorithm/model generates are the inference results that are used to make decisions, stored, analyzed, and/or the like. The action module 308 may switch live production to the second machine learning algorithm/model while the first machine learning model is being swapped, switched, retrained, and/or the like.

In some embodiments, the action module 308 correlates the comparison metrics of the first and second sets of inference data sets with one or more data deviation metrics to determine an indication of data deviation between the production data set and a training data set that is used to train a machine learning model for the first machine learning algorithm/model. As explained above, the comparison metrics may be used to determine or identify the presence of data drift or deviation in the first or production machine learning algorithm/model such that the generated inference results are different, e.g., are beyond or exceed a threshold amount from training results that the first machine learning algorithm/model generated on the training data set. The action module 308 may correlate the inference results that are generated on the production data set with training results that were generated on the training data set to determine whether there is data deviation or drift, and if so, taking an action such as switching or retraining a machine learning model to correct for the data deviation.

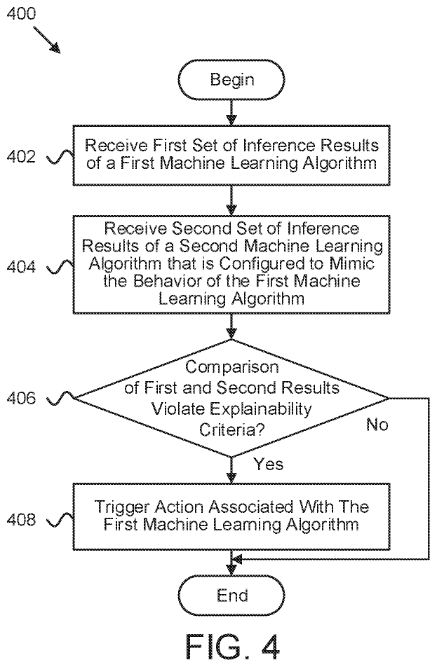

FIG. 4 is a schematic flow chart diagram illustrating one embodiment of a method 400 for interpretability-based machine learning adjustment during production. In one embodiment, the method 400 begins and the first results module 302 receives 402 a first set of inference results of a first machine learning algorithm/model during inference of a production data set. The first machine learning algorithm/model may be used during live production or deployment on live, real-time, production data.

In one embodiment, the second results module 304 receives 404 a second set of inference results of a second machine learning algorithm/model during inference of the production data set. The second machine learning algorithm/model may be different than the first machine learning algorithm/model and may be configured to mimic a behavior of the first machine learning algorithm/model.

In various embodiments, the comparison module 306 compares 406 the first and second inference results to calculate a comparison metric and determine whether the comparison metric violates explainability criteria. If not, the method 400 ends. Otherwise, the action module 308 triggers 408 one or more actions related to the first machine learning algorithm/model in response to a comparison of the first and second sets of inference results not satisfying explainability criteria, and the method 400 ends.

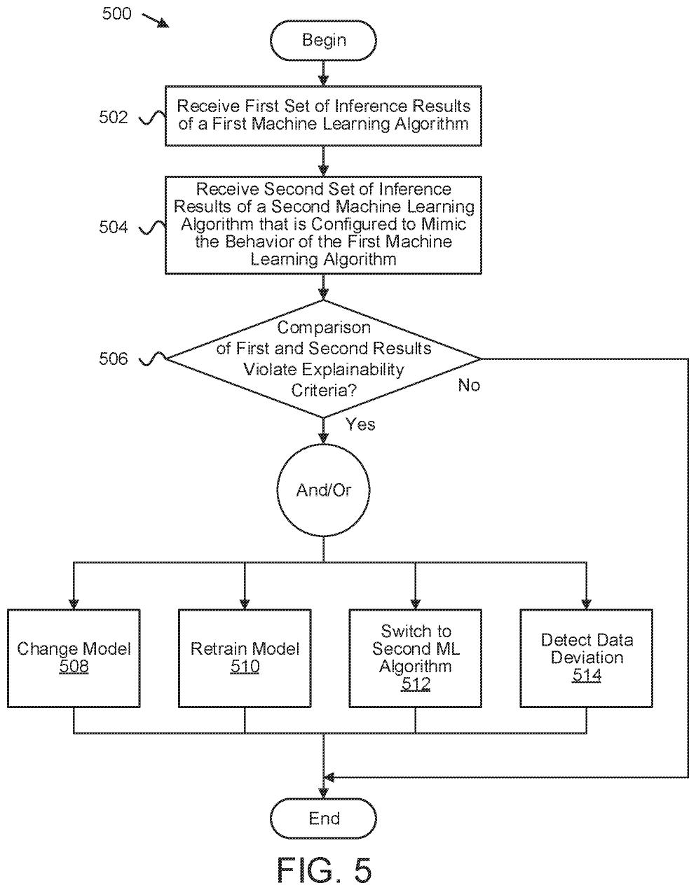

FIG. 5 is a schematic flow chart diagram illustrating another embodiment of a method 500 for interpretability-based machine learning adjustment during production. In one embodiment, the method 500 begins and the first results module 302 receives 502 a first set of inference results of a first machine learning algorithm/model during inference of a production data set. The first machine learning algorithm/model may be used during live production or deployment on live, real-time, production data.

In one embodiment, the second results module 304 receives 504 a second set of inference results of a second machine learning algorithm/model during inference of the production data set. The second machine learning algorithm/model may be different than the first machine learning algorithm/model and may be configured to mimic a behavior of the first machine learning algorithm/model.

In various embodiments, the comparison module 306 compares 506 the first and second inference results to calculate a comparison metric and determine whether the comparison metric violates explainability criteria. If not, the method 500 ends. Otherwise, the action module 308 triggers one or more actions related to the first machine learning algorithm/model in response to a comparison of the first and second sets of inference results not satisfying explainability criteria.

For instance, the action module 308 may change 508 the machine learning model for the first machine learning algorithm that is in production, may retrain 510 the machine learning model for the first machine learning algorithm that is in production, may switch 512 live production to the second machine learning algorithm, and/or may detect data deviation or data drift 514 by correlating the comparison metrics from the comparison of the first and second inference results with comparison metrics from training results that the first and second machine learning algorithms/models generate using training data, and the method 500 ends.

Means for receiving a first set of inference results of a first machine learning algorithm during inference of a production data set includes, in various embodiments, one or more of an ML management apparatus 104, a first results module 302, a device driver, a controller executing on a host computing device, a processor, an FPGA, an ASIC, other logic hardware, and/or other executable code stored on a computer-readable storage medium. Other embodiments may include similar or equivalent means for receiving a first set of inference results of a first machine learning algorithm during inference of a production data set.

Means for receiving a second set of inference results of a second machine learning algorithm during inference of the production data set includes, in various embodiments, one or more of an ML management apparatus 104, a second results module 304, a device driver, a controller executing on a host computing device, a processor, an FPGA, an ASIC, other logic hardware, and/or other executable code stored on a computer-readable storage medium. Other embodiments may include similar or equivalent means for receiving a second set of inference results of a second machine learning algorithm during inference of the production data set.

Means for triggering one or more actions related to the first machine learning algorithm in response to a comparison of the first and second sets of inference results not satisfying explainability criteria includes, in various embodiments, one or more of an ML management apparatus 104, an action module 308, a device driver, a controller executing on a host computing device, a processor, an FPGA, an ASIC, other logic hardware, and/or other executable code stored on a computer-readable storage medium. Other embodiments may include similar or equivalent means for triggering one or more actions related to the first machine learning algorithm in response to a comparison of the first and second sets of inference results not satisfying explainability criteria.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a first results module configured to receive a first set of inference results of a first machine learning algorithm during inference of a production data set, the first machine learning algorithm used during live production;
a second results module configured to receive a second set of inference results of a second machine learning algorithm during inference of the production data set, the second machine learning algorithm different than the first machine learning algorithm and configured to mimic a behavior of the first machine learning algorithm; and
an action module configured to trigger one or more actions related to the first machine learning algorithm in response to a comparison of the first and second sets of inference results not satisfying explainability criteria.

2. The apparatus of claim 1, further comprising a comparison module configured to:
compare the first and second sets of inference results using a comparison metric; and
determine whether the comparison metric for the first and second sets of inference results satisfies explainability criteria for the first machine learning algorithm, the explainability criteria comprising an explainability threshold for the comparison metric.

3. The apparatus of claim 2, wherein the comparison module compares each result of the first and second sets of inference results on a result-by-result basis.

4. The apparatus of claim 2, wherein the comparison module compares subsets of the first and second sets of inference results, the subsets comprising a predefined number of results.

5. The apparatus of claim 2, wherein the comparison module is further configured to compare comparison metrics for the first and second sets of results generated based on the production data set to comparison metrics for the first and second sets of results generated based on a training data set to detect data deviation from the training data set.

6. The apparatus of claim 1, wherein the second machine learning algorithm is selected from a plurality of possible machine learning algorithms by determining which of the plurality of possible machine learning algorithms generates results of a training data set that are within a threshold value of results that the first machine learning algorithm generates for the training data set.

7. The apparatus of claim 1, wherein the one or more actions comprises sending an alert notification that the explainability criteria was not satisfied, the alert notification comprising one or more recommendations for responding to the explainability criteria violation.

8. The apparatus of claim 1, wherein the one or more actions comprises dynamically changing a current machine learning model for the first machine learning algorithm to a different machine learning model that satisfies the explainability criteria.

9. The apparatus of claim 1, wherein the one or more actions comprises retraining a machine learning model for the first machine learning algorithm using training data that generates inference results that satisfy the explainability criteria.

10. The apparatus of claim 1, wherein the one or more actions comprises dynamically switching live production of inference of the production data set to the second machine learning algorithm.

11. The apparatus of claim 1, wherein the one or more actions comprises correlating the comparison of the first and second sets of inference data with one or more data deviation metrics to determine an indication of data deviation between the production data set and a training data set that is used to train a machine learning model for the first machine learning algorithm.

12. The apparatus of claim 1, wherein the one or more actions are automatically triggered without receiving confirmation from a user to perform the one or more actions.

13. A method, comprising:
receiving a first set of inference results of a first machine learning algorithm during inference of a production data set, the first machine learning algorithm used during live production;
receiving a second set of inference results of a second machine learning algorithm during inference of the production data set, the second machine learning algorithm different than the first machine learning algorithm and configured to mimic a behavior of the first machine learning algorithm; and
triggering one or more actions related to the first machine learning algorithm in response to a comparison of the first and second sets of inference results not satisfying explainability criteria.

14. The method of claim 13, further comprising:
comparing the first and second sets of inference results using a comparison metric; and
determining whether the comparison metric for the first and second sets of inference results satisfies explainability criteria for the first machine learning algorithm, the explainability criteria comprising an explainability threshold for the comparison metric.

15. The method of claim 14, further comprising comparing comparison metrics for the first and second sets of results generated based on the production data set to comparison metrics for the first and second sets of results generated based on a training data set to detect data deviation from the training data set.

16. The method of claim 13, wherein the second machine learning algorithm is selected from a plurality of possible machine learning algorithms by determining which of the plurality of possible machine learning algorithms generate results of a training data set that are within a threshold value of results that the first machine learning algorithm generates for the training data set.

17. The method of claim 13, wherein the one or more actions comprises dynamically changing a current machine learning model for the first machine learning algorithm to a different machine learning model that satisfies the explainability criteria.

18. The method of claim 13, wherein the one or more actions comprises dynamically switching live production of inference of the production data set to the second machine learning algorithm.

19. The method of claim 13, wherein the one or more actions comprises correlating the comparison of the first and sets of inference data with one or more data deviation metrics to determine an indication of data deviation between the production data set and a training data set that is used to train a machine learning model for the first machine learning algorithm.

20. An apparatus comprising:
means for receiving a first set of inference results of a first machine learning algorithm during inference of a production data set, the first machine learning algorithm used during live production;
means for receiving a second set of inference results of a second machine learning algorithm during inference of the production data set, the second machine learning algorithm different than the first machine learning algorithm and configured to mimic a behavior of the first machine learning algorithm; and
means for triggering one or more actions related to the first machine learning algorithm in response to a comparison of the first and second sets of inference results not satisfying explainability criteria.
